(19) United States
(12) Patent Application Publication
(10) Pub. No.: US 2014/0070616 A1
(43) Pub. Date: Mar. 13, 2014

(54) POWER CONVERSION OUTPUT ARCHITECTURE

(71) Applicants: Tsun-Te Shih, New Taipei City (TW); Yu-Yuan Chang, New Taipei City (TW); Chun-Lung Su, New Taipei City (TW); Heng-Chia Chang, New Taipei City (TW)

(72) Inventors: Tsun-Te Shih, New Taipei City (TW); Yu-Yuan Chang, New Taipei City (TW); Chun-Lung Su, New Taipei City (TW); Heng-Chia Chang, New Taipei City (TW)

(21) Appl. No.: 13/609,671

(22) Filed: Sep. 11, 2012

(51) Int. Cl. H02J 9/00

(52) U.S. Cl. 307/64

(57) ABSTRACT

A power conversion output architecture applied to a redundant power supply system comprises a power integration panel and a power regulation output panel. The power integration panel includes a first integration circuit receiving primary power from a plurality of power supplies and integrating them into primary power integration, and a second integration circuit receiving standby power from the power supplies and integrating them into standby power integration. The power regulation output panel includes a power regulation circuit receiving the primary power integration and converting it into a secondary power, a first output circuit receiving and outputting the secondary power, a second output circuit receiving and outputting the primary power integration, a third output circuit receiving and outputting the standby power integration, and a power administration unit detecting the status of the primary power integration, the standby power integration and the secondary power.

### FIELD OF THE INVENTION

The present invention relates to a power conversion output architecture, particularly to a power conversion output architecture applied to a redundant power supply system.

### BACKGROUND OF THE INVENTION

In order to prevent sudden failure at the power supply end, or damage of computer systems or abrupt loss of digital data for operation caused by surges generated by switching to backup power, high-end computer systems usually adopt an N+M redundant power supply system to maintain normal operation and to avoid power outage. In the N+M redundant power supply system, N denotes the number of the power supplies that are assembled to sustain the total power of loads required by the computer system, and M denotes the allowed number of damaged power supplies. Normally, M≧1 and N≧1. On the other hand, with the advances of computer technology, the specification of the motherboards also has been reformed several times, and nowadays ATX has become the mainstream. Under the ATX specification, it requires operation power of 3.3V, 5V_{STB}, 5V, +12V and −12V. However, a common power supply only provides a primary power of +12V and a standby power of 5V_{STB}. Therefore, voltage regulation module (VRM) is normally arranged in a power supply to modulate the primary power into the above-mentioned operation power with different voltages.

A redundant power supply system normally uses a power conversion output architecture to supply power to the motherboard. Please refer to FIG. 1 for a block diagram showing a conventional power conversion output architecture applied to a redundant power supply system. The conventional power conversion output architecture 1 comprises a first power panel 11 and a second power panel 12. The first power panel 11 is electrically connected to the power supplies 2 and 2a of the redundant power supply system and receives primary power and standby power from the power supplies 2 and 2a. After receiving the primary power and the standby power, the first power panel 11 outputs them to a motherboard 3. The first power panel 11 also outputs the primary power to the second power panel 12. After receiving the primary power, the second power panel 12 modulates it through a power regulation circuit 121 arranged thereon to generate a secondary power and output the secondary power to the motherboard 3. The conventional power conversion output architecture 1 can indeed provide power with various voltages under the ATX specification. However, both the first and second power panels 11 and 12 output power to the motherboard 3 through wires that causes the conventional power conversion output architecture 1 to have a complicated wiring layout and impede inspection and maintenance. Furthermore, in order to ensure that the motherboard 3 can receive the power normally, the redundant power supply system is required to provide the status signals of the output power (the so-called PG signals means “Power Good”). Therefore, the conventional power conversion output architecture 1 includes a power administration unit 122 to detect the output power. If the power administration unit 122 is arranged on the second power panel 12, the first power panel 11 requires an additional electrical wire to output the standby power to the second power panel 12 to be detected by the power administration unit 122. In FIG. 1, although the power administration unit 122 is arranged on the second power panel 12 as an example, the power administration unit 122 may be alternatively arranged on the first power panel 11 if it is required according to the layout design. In such a case, the second power panel 12 requires an additional electrical wire to output the secondary power to the first power panel 11. Specifically, whether the power administration unit 122 is arranged on the first power panel 11 or on the second power panel 12, the wiring between the two panels is complicated. Therefore, a power conversion output architecture with simplified wiring layout is needed to solve the aforesaid problems.

### SUMMARY OF THE INVENTION

The primary objective of the present invention is to overcome the problem of complicated wiring in the conventional power conversion output architecture.

To achieve the above-mentioned objective, the present invention proposes a power conversion output architecture applied to a redundant power supply system having N+M power supplies, wherein M≧1 and N≧1. Each of the power supplies respectively outputs a primary power having a first voltage level and a standby power having a second voltage level. The second voltage level of the standby power is smaller than the first voltage level of the primary power. The power conversion output architecture of the present invention comprises a power integration panel and a power regulation output panel. The power integration panel is electrically connected to the power supplies and includes a first integration circuit which receives the primary power from the power supplies and integrates the primary power into primary power integration, and a second integration circuit which receives the standby power from the power supplies and integrates the standby power into standby power integration. The power regulation output panel includes a power regulation circuit which receives the primary power integration from the first integration circuit and converts the primary power integration into a secondary power, a first output circuit which receives the secondary power from the power regulation circuit for outputting, a second output circuit which receives the primary power integration from the first integration circuit for outputting, a third output circuit which receives the standby power integration from the second integration circuit for outputting, and a power administration unit electrically connected to the first output circuit, the second output circuit and the third output circuit to respectively receive the primary power integration, the standby power integration and the secondary power to detect power output status thereof and to generate an administration signal. In one embodiment, the power regulation circuit includes at least one power regulation unit to convert the primary power integration into the secondary power.

In one embodiment, the voltage of the secondary power is selected from a group consisting of 3.3V, 5V, and −12V.

In one embodiment, the primary power and the primary power integration respectively have a voltage of 12V.

In one embodiment, the standby power and the standby power integration respectively have a voltage of 5V.

In one embodiment, the power regulation output panel further comprises a radiator arranged on the power regulation circuit to cool the power regulation circuit.

Compared with the conventional technology, the power conversion output architecture of the present invention substantially achieves the advantage of simplified wiring. The power conversion output architecture of the present invention has only one panel to be wired to output power instead of using two panels to be wired at the same time to output power in the conventional power conversion output architecture. That is to say the present invention mainly uses the power regulation output panel to perform power output. Therefore, under the architecture of the present invention, power is conducted only through a single path and is converted and output via the power regulation output panel. Thereby a complicated wiring layout can be avoided and the power also can be prevented from conducting reciprocally between the two panels.

### BRIEF DESCRIPTION OF THE DRAWINGS

FIG. 1 is a block diagram showing a conventional power conversion output architecture applied to a redundant power supply system.

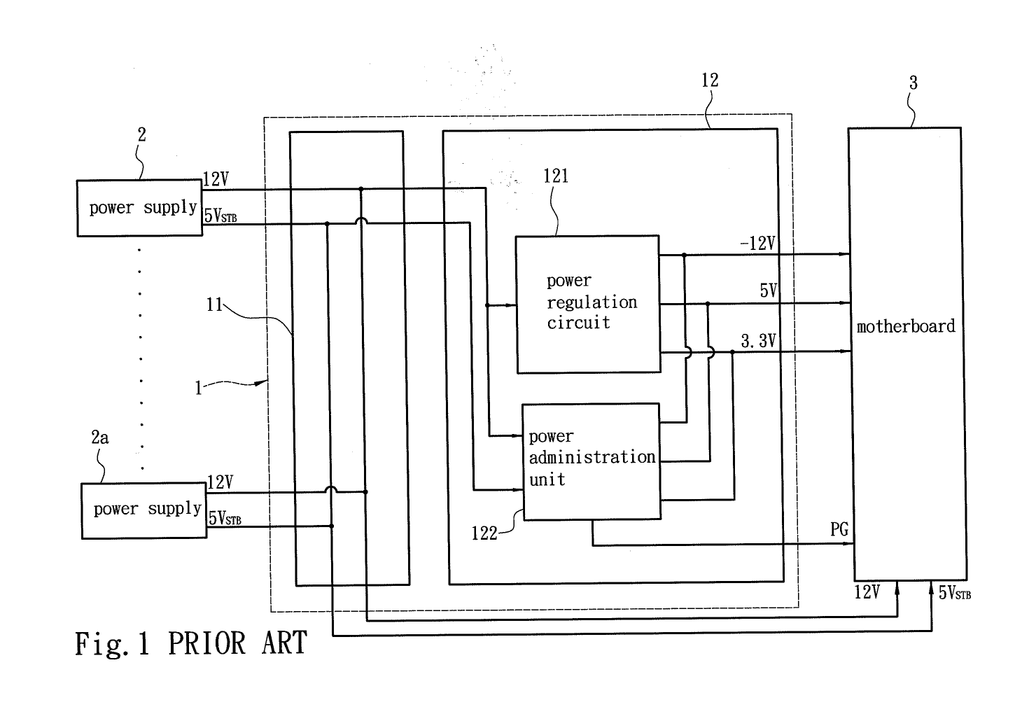

FIG. 2 is a block diagram showing a power conversion output architecture according to one embodiment of the present invention.

### DETAILED DESCRIPTION OF THE PREFERRED EMBODIMENTS

The technical contents of the present invention are described in detail in cooperation with drawings below.

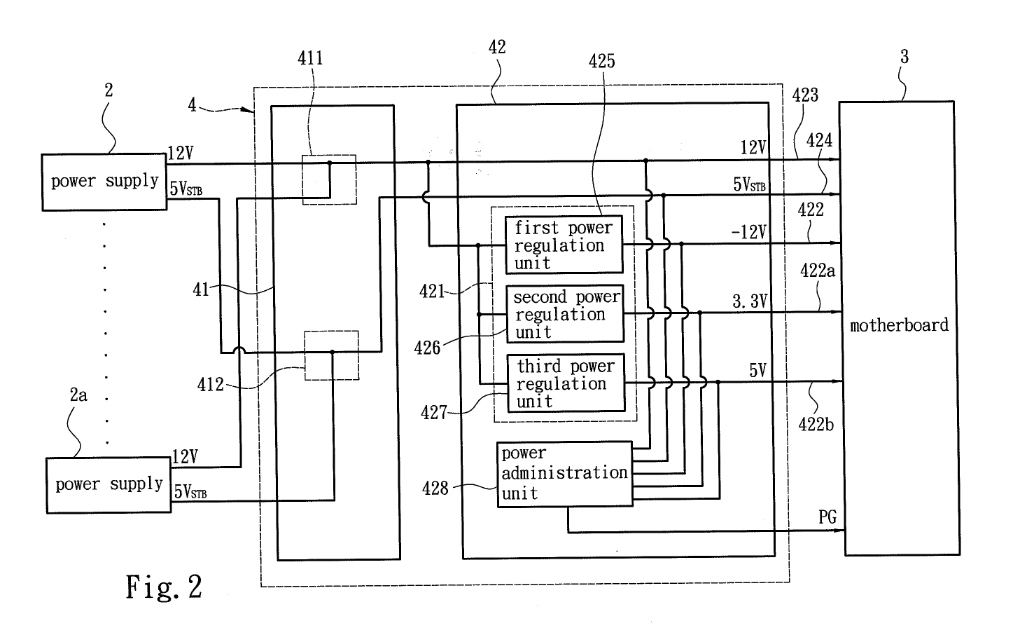

Please refer to FIG. 2 for a block diagram showing the power conversion output architecture according to one embodiment of the present invention. The power conversion output architecture of the present invention is applied to a redundant power supply system having N+M power supplies, wherein M≧1 and N≧1. In this embodiment, the redundant power supply system includes at least two power supplies 2 and 2a. Each of the power supplies 2 and 2a outputs a primary power having a first voltage level and a standby power having a second voltage level. The second voltage level of the standby power is smaller than the first voltage level of the primary power. The power conversion output architecture 4 is electrically connected to the power supplies 2 and 2a to receive the primary power and the standby power. The power conversion output architecture 4 comprises a power integration panel 41 and a power regulation output panel 42, wherein the power integration panel 41 is electrically connected to the power supplies 2 and 2a. The power integration panel 41 includes a first integration circuit 411 which receives the primary power from the power supplies 2 and 2a and integrates the primary power into primary power integration, and a second integration circuit 412 which receives the standby power from the power supplies 2 and 2a and integrates the standby power into standby power integration. The first integration circuit 411 and the second integration circuit 412 may be parallel with each other. The power regulation output panel 42 includes a power regulation circuit 421 which receives the primary power integration from the first integration circuit 411 and converts the primary power integration into a secondary power with a voltage level different from that of the primary power, a first output circuit 422 which receives the secondary power from the power regulation circuit 421 for outputting, a second output circuit 423 which receives the primary power integration from the first integration circuit 411 for outputting, and a third output circuit 424 which receives the standby power integration from the second integration circuit 412 for outputting. The first, second and third output circuits 422, 423 and 424 may be electrically connected to a motherboard 3 or an electronic device (not shown in the drawing) separately to respectively output the primary power integration, the standby power integration and the secondary power to the motherboard 3 or the electronic device.

Refer to FIG. 2 again. In order to simultaneously provide the secondary power with different voltage levels, at least two power regulation units are arranged in the power regulation circuit 421 of the power regulation output panel 42. As shown in FIG. 2, taking a first power regulation unit 425, a second power regulation unit 426, and a third power regulation unit 427 as an example. The first, second and third power regulation units 425, 426 and 427 respectively receive the primary power integration to perform conversion, and the voltage levels of the secondary power converted by them may be different. The first, second and third power regulation units 425, 426 and 427 respectively output the secondary power via the first output circuits 422, 422a and 422b. This embodiment is only to exemplify the present invention, but it is not a limitation of the present invention. The number of the first output circuits 422 is corresponding to the number of the power regulation units. To further illustrate implementation of the power conversion out architecture of the present invention, an ATX specification is used as an example. In this embodiment, each of the power supplies 2 and 2a outputs a primary power of 12V and a standby power of 5V (normally designated by 5V_{STB}). In other words, the power conversion output architecture 4 respectively receives primary power of 12V and standby power of 5V. From the forgoing embodiment, it is known that after the power integration panel 41 receives the primary power and standby power from the power supplies 2 and 2a, it then integrates them into the primary power integration and the standby power integration respectively. In fact, the power integration panel 41 integrates the primary power in a whole, i.e. the voltage of the primary power integration is equal to the voltage of the primary power. This is also the same for the standby power integration and the standby power. Therefore, the voltages of the primary power integration and the standby power integration are respectively 12V and 5V (also designated by 5V_{STB}). The power regulation output panel 42 receives the primary power integration and the standby power integration and then outputs them to the motherboard 3 via the second output circuit 423 and the third output circuit 424. On the other hand, the power regulation circuit 421 receives the primary power integration and then uses its at least one power regulation unit to perform power conversion. In this embodiment, the first, second and third power regulation units 425, 426 and 427 are used to perform power conversion and respectively generate secondary power of 3.3V, 5V and −12V. The secondary power is then outputted to the motherboard 3 via the first output circuits 422a, 422b and 422 respectively. Thereby, the power of 3.3V, 5V_{STB}, +12V, 5V and −12V required by the ATX specification is generated.

Moreover, during power conversion, the power regulation circuit 421 generates heat which may affect the performance of the power regulation circuit 421 if it cannot be dissipated effectively. Therefore, the power regulation output panel 42 can further comprise a radiator arranged on the power regulation circuit 421 to cool the power regulation circuit 421. The radiator may have various types, thus details are omitted herein.

Furthermore, the motherboard 3 normally needs to detect whether the power outputted by the power supplies is stable. Therefore, a power administration unit 428 is provided to be arranged on the power regulation output panel 42. The power administration unit 428 is electrically connected to the first, second and third output circuits 422, 423 and 424 to receive the primary power integration, the standby power integration and the secondary power to detect the power output status thereof. The power administration unit 428 then generates power administration signals (the so-called PG signals) according to the detection results and outputs the power administration signals to the motherboard 3 or the electronic device (not shown in the drawing) for power administration.

As illustrated above, the power conversion output architecture of the present invention mainly uses the power regulation output panel to perform power conversion and power output. The power integration panel only performs power integration but not be wired to output power. Therefore, the present invention solves the problem of complicated wiring in conventional power conversion output architecture in which power is outputted via two separate panels and conducted reciprocally between these two panels as well to further result in difficulty in assembly or maintenance.

The embodiments described above are only to exemplify the present invention but not to limit the scope of the present invention. Any equivalent modification or variation according to the spirit of the present invention is to be also included within the scope of the present invention.

What is claimed is:

1. A power conversion output architecture applied to a redundant power supply system, the redundant power supply system including N+M power supplies, wherein M≧1 and N≧1, each of the N+M power supplies respectively and independently outputting a primary power with a first voltage level and a standby power with a second voltage level, the second voltage level of the standby power being smaller than the first voltage level of the primary power, the power conversion output architecture comprising:
a power integration panel which is electrically connected to the N+M power supplies, and includes a first integration circuit to receive the primary power from the N+M power supplies and integrate the primary power of the N+M power supplies into primary power integration and a second integration circuit to receive the standby power from the N+M power supplies and integrate the standby power of the N+M power supplies into standby power integration; and
a power regulation output panel including a power regulation circuit which receives the primary power integration from the first integration circuit and converts the primary power integration into a secondary power, a first output circuit which receives the secondary power from the power regulation circuit for outputting, a second output circuit which receives the primary power integration from the first integration circuit for outputting, a third output circuit which receives the standby power integration from the second integration circuit for outputting, and a power administration unit electrically connected to the first output circuit, the second output circuit and the third output circuit to respectively receive the primary power integration, the standby power integration and the secondary power to detect power output status thereof and to generate an administration signal.

2. The power conversion output architecture according to claim 1, wherein the power regulation circuit includes at least one power regulation unit to convert the primary power integration into the secondary power.

3. The power conversion output architecture according to claim 1, wherein a voltage of the secondary power is selected from a group consisting of 3.3V, 5V, and −12V.

4. The power conversion output architecture according to claim 1, wherein the primary power and the primary power integration respectively have a voltage of 12V.

5. The power conversion output architecture according to claim 1, wherein the standby power and the standby power integration respectively have a voltage of 5V.
